(19) United States
(12) Patent Application Publication
(10) Pub. No.: US 2015/0220077 A1
(43) Pub. Date: Aug. 6, 2015

(54) METHOD AND DEVICE FOR MEASURING A TOOL RECEIVED IN A WORKPIECE PROCESSING MACHINE

(71) Applicant: BLUM-NOVOTEST GMBH, GRUENKRAUT-GULLEN (DE)

(72) Inventors: Wolfgang Reiser, Vogt (DE); Bruno Riedter, Weingarten (DE)

(73) Assignee: BLUM-NOVOTEST GMBH, Gruenkraut-Gullen (DE)

(21) Appl. No.: 14/428,827

(22) PCT Filed: Sep. 19, 2013
(86) PCT No.: PCT/EP2013/069426

§ 371 Date: Mar. 17, 2015

(30) Foreign Application Priority Data
Sep. 26, 2012 (DE) 10 2012 019 026.3

(51) Int. Cl. G05B 19/402; G05B 15/02

(52) U.S. Cl. CPC G05B 19/402; G05B 15/02; G05B 2219/49001; G05B 2219/37618

(57) ABSTRACT

The invention relates to a method for measuring a tool received in a workpiece processing machine, the method having the following steps: providing a contact or noncontact tool sensing device for detecting positional data on the tool and for outputting signals representative of the positional data; providing an evaluation device for receiving and processing the signals and for outputting a tool geometry determined from the processed signals; detecting a sequence of a first number of positional data on the tool and outputting signals representative of said positional data to the evaluation device; processing the signals representative of the first number of positional data in order to obtain a first approximation of the tool geometry; comparing the first number of positional data to said first approximation of the tool geometry and excluding a subset of the first number of positional data depending on a predetermined criterion, in order to obtain a second number of positional data; processing the second number of positional data in order to obtain a second approximation of the tool geometry; and outputting said second approximation of the tool geometry as the tool geometry determined for the tool.

### BACKGROUND

Here a method and device for measuring a tool received in a workpiece processing machine is described.

The workpiece processing machine can be a (numerically controlled) machine tool, a (multiaxis) machining centre, a (multiaxis) milling machine or the like. Hereinafter, the term machine tool is also used for all these machines or machines of this kind. Such a machine has a spindle, on which a tool or a workpiece is mounted; the spindle can be fixedly positioned or moved and driven, for example, in three orthogonal directions X, Y, Z within a work area of the machine.

The tool can be moved by machine tool into a measuring room, an area designated for measurement, of a sensing device operating in a contact or noncontact manner. The sensing device detects the proximity of the surface, for example, using a capacitive, Inductive or optical device. For each feature, contact and noncontact sensing devices pass on corresponding measurement data to a control, which can contain a computer program. Together with the machine position information, the sensing device measurement data enable the (numerical) control to determine a precise picture of the dimensions of the tool or workpiece.

Tools inserted into a tool magazine of the machine tool must be precisely measured in length and radius before their first use in a machining process. The tool data determined for spindle speed are automatically entered in the tool table of the numerical control under a specific tool number. Subsequently, the tool data are known and available for the machining on each use of this tool.

This initial measurement is usually carried out on a clean and dry tool. Before inserting the tool into the tool magazine or after loading it into the spindle, the measuring points are mechanically manually cleaned with dry compressed air, special 3s clay or the like. It is thus ensured that the measured tool data correspond to the actual dimensions of the tool. This is necessary since, on optical measurement with the laser beam, all foreign particles (chips, coolant drops, oil film, fibres, etc.) adhering to the tool cutting edge can distort the measurement result.

If the tool dimensions are also monitored again before, during or after a machining process for compliance with a wear tolerance, the measurement takes place with a tool surface which is wet, oily and contaminated by chips, which can considerably influence the accuracy of the measurement and thus the process safety and reliability. The particles (chips) resulting during machining are influenced by the following parameters: material properties of the tool (HSS tool steel, cemented carbide with different coatings, PCD, diamond, etc.); material and material properties of the workpiece (steel, brass, copper, aluminium, etc., brittle, hard, soft, tough, tough and hard, etc.); and processing parameters (cutting speed, depth of cut, feed rate, number of cutting edges, etc.).

In order to eliminate the soiling resulting during machining on the tool cutting edge for the measurement, the following measuring and cleaning methods are used in the prior art:

Measurement with Rotating Spindle:

Due to the centrifugal forces resulting on the tool, easily adhering particles (larger chips, coolant drops, etc.) are thrown off.

Multiple Measurement at the Same Measuring Point with Monitoring of the Scattering Tolerance:

If the individual measured values due to fluctuating coolant film thickness or loose particles do not lie within an allowable scattering tolerance, a repeat measurement can be automatically carried out until the scattering tolerance is observed.

### Passive Cleaning of the Measuring Point by Means of Additional Tool Cleaning Nozzle:

Before and during the measuring process, highly focused compressed air is blown against the cutting edge to clean lightly adhering coarser particles from the measuring point. Through the additional air blast m_{L}*V_{L}, coarser chips and coolant drops are blown away from the tool surface. A thin oil and coolant film and very small chips can only be partially eliminated with this method however.

### Active Cleaning of the Measuring Point by Degreasing Cleaning Agent and Additional Tool Cleaning Nozzle:

Before and during the measuring process, the tool cutting edge is alternately sprayed with a degreasing cleaning agent, and then highly focused compressed air is blown against it to clean stickily adhering smaller particles from the measuring point. Through the degreasing cleaning agent, tough and sticky components on the tool surface are dissolved and blown away by the subsequent air blast m_{L}*V_{L} (air mass*air speed). Depending on the degreasing power, amount and exposure time of the cleaning agent used, a thin sticky oil and coolant film can be more or less (partially) removed. Here, however, the cleaning agent must be compatible with the coolant emulsion used. The additional compressed air employed atomises the cleaning liquid. This can result in harmful aerosols. An Intensify active cleaning increases the consumption of cleaning liquid and the measurement time. The particles which are the smallest and firmly adhere due to the effect of heat can thus be only removed to a limited extent.

### Active Mechanical Cleaning of the Measuring Point e.g. by Means of Moving Brushes:

Before the measuring process, coarse dirt particles are cleaned from the tool, for example, by moving brushes. The cleaning can be assisted by degreasing cleaning agents. Here, too, the cleaning agent must be compatible with the coolant emulsion used. An intensify active cleaning increases the consumption of cleaning liquid and the measurement time. The particles which are the smallest and firmly adhere due to the effect of heat can thus be only removed to a limited extent. Sharp cutting edges can be blunted by the action of mechanical forces or the brushes wear on the sharp cutting edges and produce additional Interfering particles that can accumulate and be deposited in the flutes. Overall, this is a complex and little accepted solution, since the brushes must be protected from chip deposits. The brushes must be regularly serviced and maintained.

### Active Cleaning of the Measuring Point by Means of an Ultrasonic Bath:

Before the measuring process, the dirt particles are cleaned from the tool in an ultrasonic bath. The cleaning can be assisted by degreasing cleaning agents. The coolant emulsion must be checked in each individual case. The active cleaning is achieved by a longer exposure time; this Increases the measurement time. The particles which are the smallest and firmly adhere due to the effect of heat can thus be only removed to a limited extent. This is a complex and expensive solution, since the container with the ultrasonic bath medium must be protected from chip deposits due to flying chips and coolant. The ultrasonic bath must be regularly serviced and maintained.

Alternatively to the methods described above, camera systems are also used to measure and monitor the tool geometry. An advantage of camera systems is that they can take snapshots of the tool cutting edge over several frames and can compare it with a known stored reference image of the clean tool cutting edge to detect deviations between desired and actual geometry. However, in this case a reference image must be recorded and stored for each tool/each tool geometry by means of a learning course. The evaluation is thus limited to the previously “learned” tools. The driving of the camera system and the evaluation of the camera image requires a dedicated image processing platform (computer plus software evaluation, and an additional interface between the computer and the numerical control is required. The measurement object (tool cutting edge) must be illuminated with a suitable light source. Since the optical components are very sensitive to dirt, the light source and the camera must be adequately protected against dirt and damage due to water, oil and chips. The rapidly rotating tools require a very fast image acquisition and image readout speed. The evaluation of the camera image requires high computing power and complex evaluation algorithms. The different tool diameters require a flexible setting of the focal distance or a high depth of definition of the optics. This solution is very expensive, slow and very sensitive to dirt. The achievable measuring accuracy depends on many factors, including the optical setting of the system (zoom, focal distance, image size, image detail, depth of definition, pixel size, etc).

### TECHNICAL PROBLEM

Despite active or passing cleaning of the tool cutting edge, deviations from the desired geometry may occur during measurement at any points of the cutting tool edge to be measured, due to soiling (oversize) or cutting edge wear/chipping (undersize). A complete removal of interfering particles on the tool surface cannot be continuously ensured by the described measures in the operation of the machine tool. Known solutions are too slow, too costly and/or too inaccurate for high-precision manufacturing processes.

### TECHNICAL SOLUTION

To remedy this, for measuring a tool received in a workpiece processing machine a method having the following steps is proposed:

providing a contact or noncontact tool sensing device for detecting positional data on the tool and for outputting signals representative of the positional data, providing an evaluation device for receiving and processing the signals and for outputting a tool geometry determined from the processed signals;
detecting a sequence of a first number of positional data on the tool and outputting signals representative of said positional data to the evaluation device;
processing the signals representative of the first number of positional data in order to obtain a first approximation of the tool geometry;
comparing the first number of positional data with said first approximation of the tool geometry and excluding a subset of the first number of positional data depending on a predetermined criterion, in order to obtain a second number of positional data;
processing the second number of positional data in order to obtain a second approximation of the tool geometry; and
outputting said second approximation of the tool geometry as the tool geometry determined for the tool. This tool geometry determined for the tool can then be further processed in the numerical control.

If the measuring points lie on a straight-running contour spatially close to one another or if a plurality of measured values are recorded successively at the same place and if these measured values vary to and fro between a minimum value and a maximum value (sawtooth-shaped temporal/spatial measuring course), it can be assumed with high probability that the detected minimum values reproduce the real cutting edge contour, while the measured values outside the low points are caused by disturbances (water droplets, oil film, chips). In this case, for example, firstly the cutting edge course with the disturbances can be detected as a first approximation; subsequently the measured values lying by a particular tolerance range value above the minimum value are excluded. The (at least approximate) straight line resulting from the remaining measured values corresponds to the real cutting edge of the tool.

If the measuring points lie on a continuously running contour within a spatially defined region which reproduces a definite contour shape (e.g. on a straight line, oblique line, circular shape, elliptical shape, barrel shape), the measured contour course can be approximated to the real contour course by calculating a polynomial of 1^{nd}, 2^{nd}, 3^{rd} . . . degree. Individual outliers are included here in the result with a lower weighting in relation to the total number of all the measuring points. Furthermore, the distance of each individual measured value from the calculated regression curve can be determined and on exceeding a tolerance value range can be marked as outliers. On a subsequent recalculation of the regression curve, the marked outliers are no longer used for the calculation. As a result, the deviation between measured and real tool contour becomes minimal. The function value of the polynomial at a fixedly predetermined measuring position yields the tool geometry which is sought, without distortion by incorrect individual measured values.

As noncontact sensing device, for example, also a laser system integrated into the machine tool can to measure rotating tools. For this purpose, there can be used in the machine tool the laser system which is mainly employed for breakage monitoring, but also as an independent measuring system or else as an additional sensor in multi-sensor systems. In this case, tool length and tool diameter can be measured and also shank and cutting-edge breakages detected. Furthermore, the shape monitoring of the cutting edge can be carried out by detecting chipping and wear. Moreover, the system is capable of compensating for thermal expansion of the machine shafts. By a tool measurement in the work area at nominal speed, clamping errors can be detected and effective length and radius correction values determined.

On a turning tool, the high point is the measurement-determining engagement point of the tool. This engagement point must be hit exactly by the laser beam to determine the correct measurement. Through a plurality of measuring points along the tool cutting edge, the radius of a tool circular (segment)-shaped in side view and its centre point can be calculated by means of a circular regression. The accuracy thus achievable is considerably higher than with a mechanical measuring sensing device. Tools can be practically completely measured using noncontact laser measuring technology; it allows the detection of complete tools. Thus, wear can be detected at any desired cutting-edge position, e.g. in the case of turning tools.

By detecting the tool geometry over a greater measuring range (in contrast to a single point measurement), the course and the shape of the cutting edge can be detected and evaluated in a manner similar to that with a CCD camera. In this regard, the data evaluation for an image from a CCD camera is much more costly and requires more complex image processing software and corresponding computing power. In contrast, the above-defined procedure with two or more steps allows measuring outliers to be detected and eliminated in the evaluation in a simple manner. The measurement result thus comes much closer to the real cutting edge contour of the tool than conventional approaches, with less computational cost and without the use of a camera.

Positional data on the tool are understood here as coordinates which are measured on the tool directly or indirectly. A direct measurement can in this case be a measurement which yields directly (X, Y, Z) coordinates. Alternatively to this, an indirect measurement can yield, for example, a binary signal (e.g. laser beam/not/shaded) if simultaneously the numerical control moves the spindle of the machine tool (in the X, Y, or Z direction). Then, at the moment of the binary signal change (for example shaded to not shaded laser beam, or vice versa), the position coordinates of the numerical control of the machine tool—plus the extent of the tool—are to be taken as the positional data on the tool. Thus, the positional data and the signals representing them are the coordinates which describe the tool contour of a tool geometry.

Tool geometry is understood here as the geometry (dimensions and shape of the tool) to be measured.

Before the step of detecting the positional data on the tool, in a variant the steps to be carried out are: determining a tool class; determining a contour to be measured, in particular a tool contour; specifying a characteristic quantity of the tool geometry representative of the tool class; and/or determining a sequence of sensing positions on the tool depending on the determined tool class.

There is to be determinable as the tool class a tool straight in side view and having a tool contour running parallel to the axis; a tool oblique in side view and having a tool contour not running parallel to the axis; a tool circular in side view; a tool elliptical in side view; a tool barrel-shaped in side view; or a tool having any tool contour in side view.

The predetermined criterion for excluding a subset can be in a variant

(i) a measure of a deviation of the respective positional data from said first approximation of the tool geometry; or/and (ii) a predetermined number of positional data lying farthest away from said first approximation of the tool geometry.

The detecting of the sequence of the first number of positional data on the tool can comprise positional data, the sensing positions of which on the tool are specified to lie spaced apart from one another each by approximately 10 μm to approximately 1 mm based on a predetermined sensing position on the tool or along a sensing direction on the tool.

Since the size of the interfering particles lies mostly in the micrometre range, the influence of the interfering particle can thus be at least almost completely eliminated by displacing the measuring position, for example, by a few 0.01 mm relative to a predetermined measuring point. By multiple (repeated) measurement of the tool geometry at measuring points spaced apart from one another, individual measured values can be based on an interfering contour (interfering particles). The plurality of the measured values will lie, however, on the real tool cutting edge. Through the two-stage evaluation, the outliers of the measurement in the positive direction (oversize, interfering particles) as well as outliers in the negative direction (undersize, cutting edge chipping) can be detected and distinguished from the real cutting edge contour and excluded on the determination of the tool geometry. The process safety and process reliability is thereby markedly increased.

In a variant of the method, (i) for a tool straight in side view or a tool oblique in side view, the sensing positions on the tool are specified as lying on a straight-line segment, (ii) for a tool circular, elliptical, or barrel-shaped in side view, the sensing positions on the tool are specified as lying on a circular segment, or (iii) for a tool of any shape in side view, the sensing positions on the tool are specified with the aid of a description table with precise desired coordinates of the tool contour.

The dimension of the measuring range to be examined, the number or density of the measuring points in the measuring range, the quantitative proportion of outliers to real measured values as well as the permissible size of the deviations and the procedure to get from the first number of positional data on the tool, i.e. the first approximation, to the second approximation, can be adjusted if necessary individually to the current situation (tool, measuring method, surroundings, etc.). Possible procedures which may be mentioned are averaging, minimum value determination, regression curve, etc.

If for a tool straight in side view or a tool oblique in side view, as the sequence of the first number of positional data on the tool, an at least approximately saw-tooth-shaped course is obtained as the first approximation of the tool geometry, positional data farther away from a tool origin form the subset to be excluded.

For a tool circular or barrel-shaped in side view, the first approximation of the tool geometry can be determined by a first circular regression which yields a first tool centre point and a first tool radius. The first number of positional data is compared with this first approximation of the tool geometry. A subset of the first number of positional data is excluded depending on a predetermined criterion, in order to obtain a second number of positional data. The second number of positional data is processed by means of a second circular regression which yields a second tool centre point and a second tool radius as the second approximation of the tool geometry. Said second approximation of the tool geometry is output as the tool geometry determined for the tool circular or barrel-shaped in side view and is accordingly further processed in the numerical control.

Another variant of the method has the following steps:

checking whether the positional data on the tool at least approximately reproduces a shape of the tool corresponding to a tool class; and if this is the case, approximating the measured contour course to the real contour course by means of a two-stage approximation method by calculating a geometrical function corresponding to the shape of the tool of this tool class, where outlier values in relation to the total number of all the detected positional data on the tool are at least partially eliminated or are included in the result with a lower weighting, or the distance of each individual measured value from a calculated regression curve is determined and on exceeding a tolerance is marked as outlier values and on a subsequent recalculation of the regression curve the marked outliers are no longer used for the calculation.

In this case, the steps can be carried out:

stepwise multiple displacing of the instantaneous measuring position by a few 0.01 mm relative to a predetermined first measuring position; and in each case detecting of the sequence of the first number of positional data on the tool at the instantaneous measuring position;
carrying out a plausibility check for mean value, minimum values, regression curve in order to detect possible outlier values both in the positive direction and in the negative direction and to distinguish them from a real tool contour and to filter them out on the calculation of the tool geometry.

This method can be adjusted to (i) a dimension of a measuring range to be examined, (ii) a number or a density of measuring points in the measuring range, (iii) the quantitative proportion of outlier values to further-used measured values, (iv) a permissible measure of deviations, and (v) a mathematical filter function to be applied.

### BRIEF DESCRIPTION OF THE DRAWING

Further aims, features, advantages and possible applications emerge from the following description of some exemplary embodiments and associated drawings. All of the features described and/or pictorially represented constitute, by themselves or in any combination, the subject matter disclosed here, also irrespective of their grouping in the claims or the back-references of the claims.

FIG. 1 shows a flowchart of a variant of the method presented here.

FIG. 2 shows schematically a machine tool coupled to a machine control which is adapted to receive signals from a laser measuring section.

In FIG. 3, measurement data on a tool, oblique in side view, and the two-stage processing thereof are illustrated.

In FIG. 4, measurement data on a tool, circular in side view, and the two-stage processing thereof are illustrated.

### DETAILED DESCRIPTION OF SOME EMBODIMENT VARIANTS

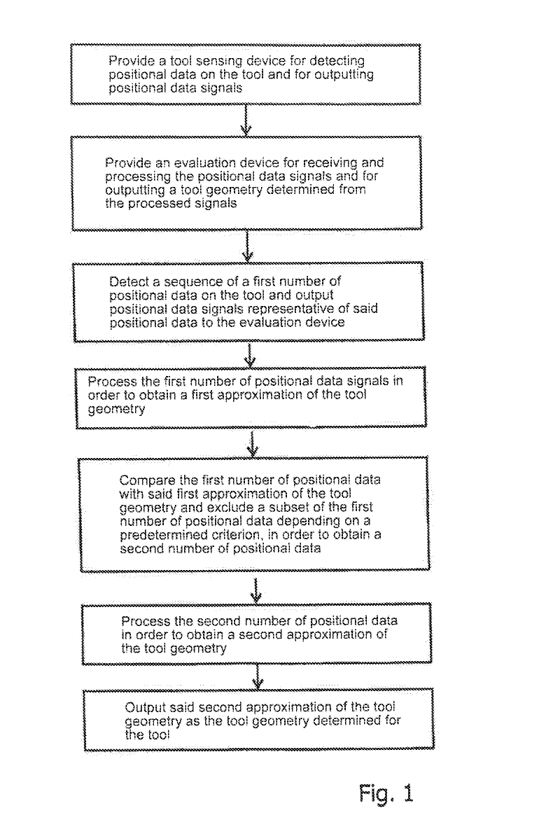

FIG. 1 shows a flowchart of a variant of the method presented here. In this case, a tool geometry is determined in a first approximation from all the measured data. Subsequently, the measured data are reduced by excluding those data from the further processing which do not meet a particular criterion with respect to the first approximation of the tool geometry. A second approximation of the tool geometry is then determined and output as the Improved approximation of the tool geometry from the reduced set of data.

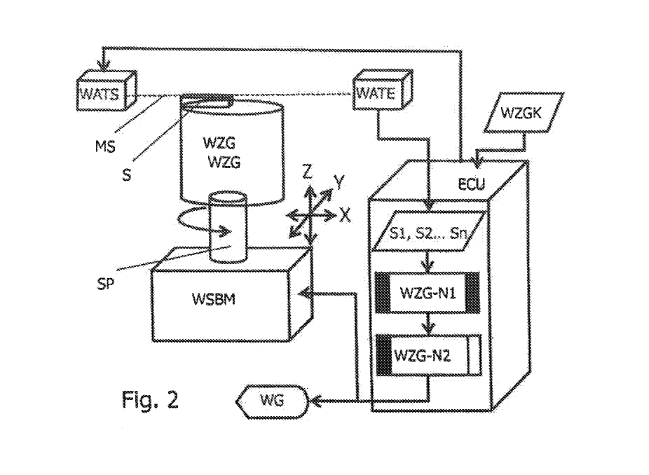

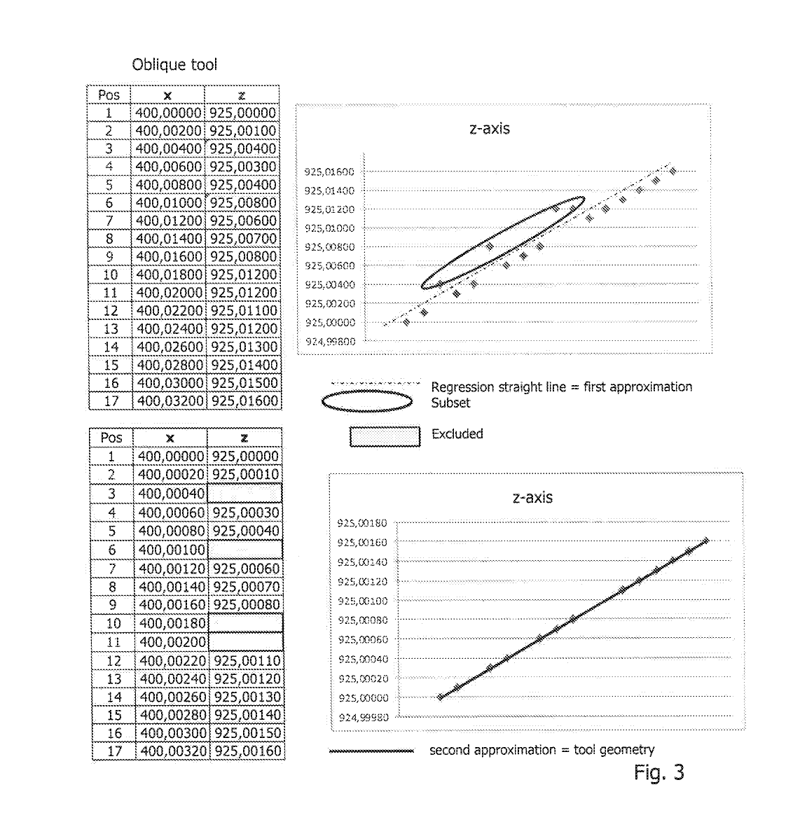

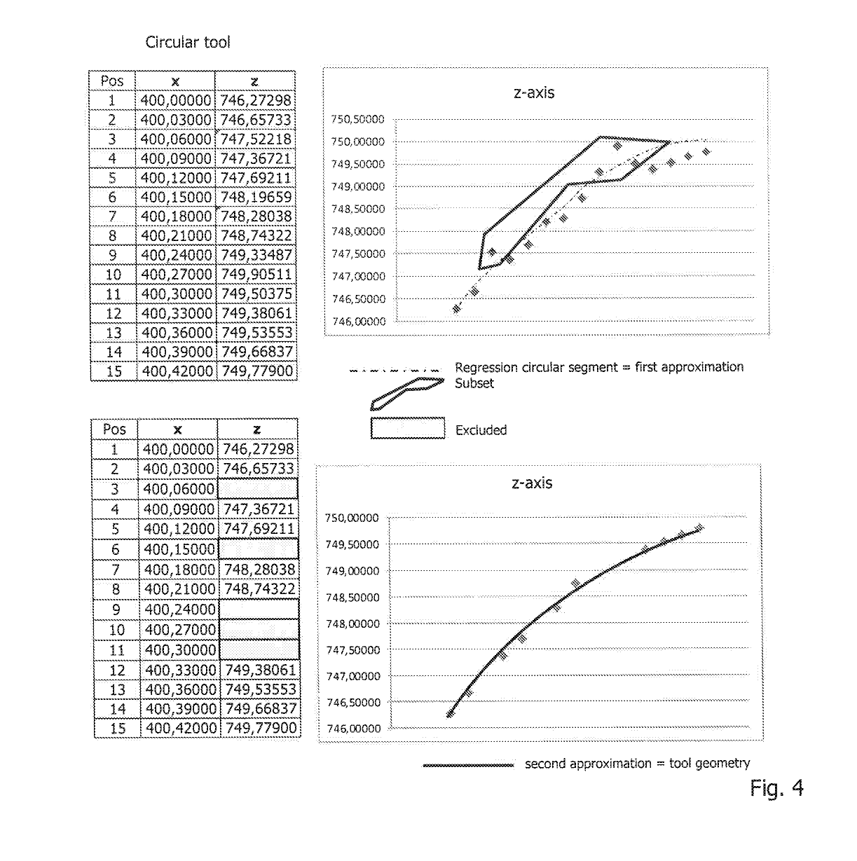

FIG. 2 of the drawing shows a tool WZG which is arranged on a spindle SP of a machine tool WSBM. In this variant the spindle SP can move in the X, Y and Z directions under the action of X, Y and Z drives (not shown in detail), which are controlled by an evaluation device ECU in the form of a numerical machine control. The tool WZG in this variant is a cutting tool with a cutting edge S which is straight in side view. But other tool or cutting edge geometries are also possible.

Instead of the tool, a workpiece can also be clamped in the spindle, the geometry of which workpiece is determined in a first approximation from all the measured data—in a comparable manner to that for a tool. Subsequently, the measured data are reduced by excluding those data from the further processing which do not meet a particular criterion with respect to the first approximation of the workpiece geometry. A second approximation of the workpiece geometry is then determined and output as the improved approximation of the workpiece geometry from the reduced set of data. Hereinafter, only the procedure/the arrangement for a measurement of and approximation of the tool geometry is described; it should, however, be understood that this also applies to workpieces analogously.

The machine tool WSBM is assigned a noncontact-measuring tool sensing device WATS, WATE in the form of a laser measuring section having a laser beam transmitter and a laser beam receiver. Details of such a laser measuring section can be found, for example, in DE 102008017349 A1, “Measuring system for noncontact measurement of tools” of Blum-Novotest GmbH, 88287 Grünkraut, DE. Such a measuring system is used for measuring on tools in a machine tool having a light barrier arrangement for determining the position of a tool or for determining the longest cutting edge of a rotating tool in the machine tool. The measuring system can have a pneumatic control in order to provide in the measuring system compressed air for different functions and at least one electronic control for operating the light barrier arrangement, for receiving measuring signals from the light barrier arrangement and for delivering measuring signals in a signal transmission medium to the machine control, and for providing control signals for the pneumatic control.

This measuring system is to be used in the cutting or material-removing machining (e.g. milling, turning, grinding, planing, drilling, countersinking or -boring, reaming, eroding and the like), also in combined turning/milling machines or milling/turning machines having stationary or rotating tools. For determining the position of a tool or for determining the longest cutting edge of a rotating tool in machine tools, a light barrier, and in particular a laser light barrier can be used. One possible procedure in this regard is to position the tool in a (laser light) measuring beam in such a manner that the beam path of the latter is interrupted by the tool. Subsequently, the tool is moved relative to the measuring beam away from the latter to a position in which the beam path of the measuring beam is (just) no longer interrupted by the tool. The tool sensing device WATS, WATE is thus adapted to emit and to receive a measuring beam MS sensing the cutting edge, and also to output corresponding signals S1, S2, . . . Sn which indicate whether the measuring beam MS is (partially) interrupted by the cutting edge S, or not. These signals are thus representative of positions along which the edge of the cutting edge S of the tool WZG extends.

The evaluation device ECU is adapted and programmed to receive and to process these signals S1, S2, . . . Sn, in order to obtain a first approximation WZG-N1 of the tool geometry thus determined, as the first (intermediate) result from the processed signals.

The evaluation device ECU is further adapted and programmed to compare the first number of positional data with said first approximation of the tool geometry WZG-N1 and to exclude a subset of the first number of positional data depending on a predetermined criterion. In this way, a second (smaller) number of positional data is obtained.

The evaluation device ECU is further adapted and programmed to process the second number of positional data in order to obtain a second, better approximation of the tool geometry WZG-N2.

The evaluation device ECU is finally adapted and programmed to output the second approximation of the tool geometry WZG-N2 as the tool geometry WG determined for the tool WZG.

In a variant, the evaluation device ECU is adapted and programmed to determine, before the determining of the positional data on the tool WZG, firstly a corresponding tool class WZGK characterising the tool. By this there can be understood, for example, a tool straight in side view and having a tool contour running parallel to the axis, a tool oblique in side view and having a tool contour not running parallel to the axis, a tool circular in side view, a tool elliptical in side view, a tool barrel-shaped in side view, or a tool having any tool contour in side view.

The evaluation device ECU is in this case adapted and programmed to determine, from the tool class WZGK characterising the tool, in a next step a contour to be measured, in particular a tool contour (straight line, oblique line, circle, ellipse, barrel, free form, etc.). The evaluation device ECU is further adapted and programmed to specify a characteristic quantity of the tool geometry representative of the tool class WZGK (for example parameters a, b of the straight-line equation y=a*x+b, or the parameters of the ellipse equation

(((xᵢ−x₀)*cos α+(yᵢ−y₀)*sin α))/a)²+(((−(xᵢ−x₀)*sin α+(yᵢ−y₀)cos α))/b)²−1=0;

where α is the angle of rotation about which the ellipse is inclined relative to the normal position, and a and b denote the semimajor axis and the semiminor axis, respectively.

Finally, the evaluation device ECU is in this case adapted and programmed to determine a sequence of sensing positions on the tool WZG depending on the determined tool class. In this regard, it is for example specified that for a tool with an oblique cutting edge ten measuring positions are to be moved to, which positions are each spaced 0.01 mm apart from one another and the first measuring position lies approximately 0.5 mm Inwards from the outer border of the tool.

The evaluation device ECU can furthermore be adapted and programmed to specify, as the predetermined criterion for excluding a subset, a measure of a deviation of the respective positional data from said first approximation of the tool geometry. Thus, if for example a straight edge is to be measured, those positional data lying more than 0.004 mm above the lowest measured value are excluded. Alternatively to this, a predetermined number, for example 30% of the measured values, of the positional data lying farthest away from the first approximation of the tool geometry can be excluded. Thus, if there are 10 measured values, for example the three highest values are excluded.

The detecting of the sequence of the first positional data on the tool is effected, for example, in such a manner that positional data are detected, the sensing positions of which on the tool WZG are specified to lie spaced apart from one another each by approximately 10 μm to approximately 1 mm based on a predetermined sensing position (for example offset inwards 5 mm from the border of the tool) on the tool WZG or along a sensing direction on the tool WZG.

In FIG. 3, it is schematically illustrated how to proceed with a tool oblique in side view. Firstly, the sensing positions on the tool are specified as lying on an oblique straight-line segment. Then, sensing is effected and the positional data detected, in this example, at 17 measuring positions. For these 17 positional data, an approximation straight line is determined as the first approximation. The 4 positional data lying farthest from this first approximation straight line (in this example No. 3, No. 6, No. 10, No. 11) are excluded. For the remaining positional data, a second approximation straight line is determined and output as the tool geometry.

In FIG. 4, it is schematically illustrated how to proceed with a tool circular in side view. Firstly, the sensing positions on the tool are specified as lying on a circular segment. For this purpose, positional data are detected over an arc of at least 30 degrees along the cutting edge of the tool. For this purpose, sensing is effected and the positional data detected, in this example, at 15 measuring positions. For these 15 positional data, as the first approximation a circle is determined by a first circular regression which yields a first tool centre point and a first tool radius. The first number of positional data is then compared with this first approximation of the tool geometry. In order to obtain a second, smaller number of positional data, a subset of the first number of positional data is excluded depending on a predetermined criterion. The 5 positional data lying farthest from this first approximation circle (in this example No. 3, No. 6, No. 9, No. 10, No. 11) are excluded. For the remaining positional data, a second approximation circle is determined and output as the tool geometry. The “excluded” criterion may, in another variant, for example, be that the distance of the respective positional data is more than 0.005 mm from the determined circle.

The variants of the method and of the device that have been described above serve only to aid understanding of the structure, method of functioning and the characteristics of the solution presented; they do not limit the disclosure to, for instance, the exemplary embodiments. The figures are schematic, with essential characteristics and effects being in some cases represented in a significantly enlarged form in order to Illustrate the functions, operating principles, technical designs and features. In this case, each method of functioning, each principle, each technical design and each feature which is/are disclosed in the figures or the text can be combined freely and as desired with all claims, each feature in the text and in the other figures, other methods of functioning, principles, technical designs and features that are contained in this disclosure or that ensue therefrom, such that all conceivable combinations are ascribable to the described solution. Also included in this case are combinations between all individual embodiments in the text, i.e. in each portion of the description, in the claims and also combinations between different variants in the text, in the claims and in the figures.

Although the product and method details explained above are represented in association, it should be pointed out that they are also independent of each other and can also be freely combined with each other. The relationships of the individual parts, and portions thereof, to each other that are shown in the figures, and the dimensions and proportions thereof, are to be understood as non-limiting. Rather, individual dimensions and proportions can also differ from those shown.

Moreover, the claims do not limit the disclosure and therefore the possibilities for combining all indicated features with each other. Here, all indicated features are also explicitly disclosed singly and in combination with all other features.

1. Method for measuring a tool (WZG) received in a workpiece processing machine (WSBM) having the steps:
providing a contact or noncontact tool sensing device (WATS, WATE) for detecting positional data on the tool (WZG) and for outputting signals (S1, S2, . . . Sn) representative of the positional data,
providing an evaluation device (ECU) for receiving and processing the signals (S1, S2, . . . Sn) and for outputting a tool geometry determined from the processed signals;
detecting a sequence of a first number of positional data on the tool (WZG) and outputting signals (S1, S2, . . . Sn) representative of said positional data to the evaluation device (ECU);
processing the signals (S1, S2, . . . Sn) representative of the first number of positional data in order to obtain a first approximation of the tool geometry (WZG-N1);
comparing the first number of positional data with said first approximation of the tool geometry (WZG-N1) and excluding a subset of the first number of positional data depending on a predetermined criterion, in order to obtain a second number of positional data;
processing the second number of positional data in order to obtain a second approximation of the tool geometry (WZG-N2); and
outputting said second approximation of the tool geometry (WZG-N2) as the tool geometry (WG) determined for the tool (WZG).

2. Method according to claim 1, in which, before the step of detecting the positional data on the tool (WZG), the steps to be carried out are:
determining a tool class (WZGK);
determining a contour to be measured, in particular a tool contour;
specifying a characteristic quantity of the tool geometry representative of the tool class (WZGK); and/or
determining a sequence of sensing positions on the tool (WZG) depending on the determined tool class.

3. Method according to claim 2, in which there is to be determined, as the tool class (WZGK),
(i) a tool straight in side view and having a tool contour running parallel to the axis;
(ii) a tool oblique in side view and having a tool contour not running parallel to the axis;
(iii) a tool circular in side view;
(iv) a tool elliptical in side view;
(v) a tool barrel-shaped in side view; or
(vi) a tool having any tool contour in side view.

4. Method according to claim 1 or 2, in which the predetermined criterion for excluding a subset is
(i) a measure of a deviation of the respective positional data from said first approximation of the tool geometry (WZG-N1); or/and
(ii) a predetermined number of positional data lying farthest away from said first approximation of the tool geometry (WZG-N1).

5. Method according to one of the preceding claims, in which the detecting of the sequence of the first number of positional data on the tool (WZG) comprises positional data, the sensing positions of which on the tool (WZG) are specified to lie spaced apart from one another each by approximately 10 μm to approximately 1 mm based on a predetermined sensing position on the tool (WZG) or along a sensing direction on the tool (WZG).

6. Method according to the preceding claim, in which
(i) for a tool (WZG) straight in side view or a tool (WZG) oblique in side view, the sensing positions on the tool (WZG) are specified as lying on a straight-line segment,
(ii) for a tool (WZG) circular, elliptical, or barrel-shaped in side view, the sensing positions on the tool (WZG) are specified as lying on a circular segment, or
(iii) for a tool (WZG) of any shape in side view, the sensing positions on the tool (WZG) are specified with the aid of a description table with precise desired coordinates of the tool contour.

7. Method according to one of the preceding claims, in which, if for a tool straight in side view or a tool oblique in side view, as the sequence of the first number of positional data on the tool (WZG), an at least approximately saw-tooth-shaped course is obtained as the first approximation of the tool geometry (WZG-N1), positional data farther away from a tool origin (WZGNULL) form the subset to be excluded.

8. Method according to one of the preceding claims, in which
(i) for a tool (WZG) circular or barrel-shaped in side view, the first approximation of the tool geometry (WZG-N1) is determined by a first circular regression which yields a first tool centre point and a first tool radius,
(ii) the first number of positional data is compared with this first approximation of the tool geometry (WZG-N1),
(iii) a subset of the first number of positional data is excluded depending on a predetermined criterion, in order to obtain a second number of positional data;
(iv) the second number of positional data is processed by means of a second circular regression which yields a second tool centre point and a second tool radius as the second approximation of the tool geometry (WZG-N2); and
(v) outputting said second approximation of the tool geometry (WZG-N2) as the tool geometry (WG) determined for the tool (WZG) circular or barrel-shaped in side view.

9. Method according to one of the preceding claims, having the steps:
checking whether the positional data on the tool (WZG) at least approximately reproduces a shape of the tool corresponding to a tool class; and if this is the case,
approximating the measured contour course to the real contour course by means of a two-stage approximation method by calculating a geometrical function corresponding to the shape of the tool of this tool class, where outlier values in relation to the total number of all the detected positional data on the tool (WZG) are at least partially eliminated or are included in the result with a lower weighting, or the distance of each individual measured value from a calculated regression curve is determined and on exceeding a tolerance is marked as outlier values and on a subsequent recalculation of the regression curve the marked outliers are no longer used for the calculation.

10. Method according to one of the preceding claims, having the steps:
displacing the measuring position by a few 0.01 mm relative to a predetermined measuring position;
multiple repeating of the detecting of the sequence of the first number of positional data on the tool (WZG) at measuring positions lying close to one another;
carrying out a plausibility check for mean value, minimum values, regression curve in order to detect outlier values both in the positive direction and in the negative direction and to distinguish them from a real tool contour and to filter them out on the calculation of the tool geometry.

11. Method according to the preceding claim, wherein
(i) a dimension of a measuring range to be examined,
(ii) a number or a density of measuring points in the measuring range,
(iii) the quantitative proportion of outlier values to further-used measured values,
(iv) a permissible measure of deviations, and
(v) a mathematical filter function to be applied
are adjusted.

12. Measuring device for a tool (WZG) received in a workpiece processing machine (WSBM) having: a contact- or noncontact-measuring tool sensing device (WATS, WATE) for detecting positional data on the tool (WZG) and for outputting signals (S1, S2, . . . Sn) representative of the positional data, which sensing device is adapted to detect a sequence of a first number of positional data on the tool (WZG) and to output signals (S1, S2, . . . Sn) representative of said positional data to an evaluation device (ECU), which is adapted to receive and to process the signals (S1, S2, . . . Sn) and to output a tool geometry determined from the processed signals, by
processing the signals (S1, S2, . . . Sn) representative of the first number of positional data in order to obtain a first approximation of the tool geometry (WZG-N1);
comparing the first number of positional data with said first approximation of the tool geometry (WZG-N1) and excluding a subset of the first number of positional data depending on a predetermined criterion, in order to obtain a second number of positional data;
processing the second number of positional data in order to obtain a second approximation of the tool geometry (WZG-N2); and
outputting said second approximation of the tool geometry (WZG-N2) as the tool geometry (WG) determined for the tool (WZG).

13. Measuring device according to claim 12, in which the evaluation device (ECU) is adapted to the following:
determine a tool class (WZGK);
determine a contour to be measured, in particular a tool contour;
specify a characteristic quantity of the tool geometry representative of the tool class (WZGK); and/or
determine a sequence of sensing positions on the tool (WZG) depending on the determined tool class.

14. Measuring device according to claim 13, in which the evaluation device (ECU) is adapted to determine, as the tool class (WZGK),
(i) a tool straight in side view and having a tool contour running parallel to the axis;
(ii) a tool oblique in side view and having a tool contour not running parallel to the axis;
(iii) a tool circular in side view;
(iv) a tool elliptical in side view;
(v) a tool barrel-shaped in side view; or
(vi) a tool having any tool contour in side view.

15. Measuring device according to one of claims 12 to 14, in which the evaluation device (ECU) is adapted to determine, as the predetermined criterion for excluding a subset,
(i) a measure of a deviation of the respective positional data from said first approximation of the tool geometry (WZG-N1); or/and
(ii) a predetermined number of positional data lying farthest away from said first approximation of the tool geometry (WZG-N1).

16. Measuring device according to one of claims 12 to 15, in which the evaluation device (ECU) is adapted, on the detecting of the sequence of the first number of positional data on the tool (WZG), to detect those positional data, the sensing positions of which on the tool (WZG) are specified to lie spaced apart from one another each by approximately 10 μm to approximately 1 mm based on a predetermined sensing position on the tool (WZG) or along a sensing direction on the tool (WZG).

17. Measuring device according to the preceding claim, in which the evaluation device (ECU) is adapted,
(i) for a tool (WZG) straight in side view or a tool (WZG) oblique in side view, to specify the sensing positions on the tool (WZG) as lying on a straight-line segment,
(ii) for a tool (WZG) circular, elliptical, or barrel-shaped in side view, to specify the sensing positions on the tool (WZG) as lying on a circular segment, or
(iii) for a tool (WZG) of any shape in side view, to specify the sensing positions on the tool (WZG) with the aid of a description table with precise desired coordinates of the tool contour.

18. Measuring device according to one of claims 12 to 17, in which the evaluation device (ECU) is adapted, if for a tool straight in side view or a tool oblique in side view, as the sequence of the first number of positional data on the tool (WZG), an at least approximately saw-tooth-shaped course is obtained as the first approximation of the tool geometry (WZG-N1), to take positional data farther away from a tool origin (WZGNULL) as the subset to be excluded.

19. Measuring device according to one of claims 12 to 18, in which the evaluation device (ECU) is adapted, for a circular, or barrel-shaped tool (WZG), the first approximation of the tool geometry (WZG-N1) is determined by a first circular regression which yields a first tool centre point and a first tool radius.
